(19) United States
(12) Patent Application Publication
(10) Pub. No.: US 2018/0079888 A1
(43) Pub. Date: Mar. 22, 2018

(54) A FIRE RETARDANT AGENT AND USE THEREOF

(71) Applicant: AB MIDNIGHT HOLDING, Lemland (FI)

(72) Inventors: Hakan WIKLUND, Oja (FI); Jonas WIKLUND, Oja (FI); Simon WIKLUND, Lemland (FI)

(21) Appl. No.: 15/578,978

(22) PCT Filed: Jun. 1, 2016
(86) PCT No.: PCT/EP2016/062404

§ 371 Date: Dec. 1, 2017

(30) Foreign Application Priority Data
Jun. 1, 2015 (EP) 15170147.1

(51) Int. Cl. C08K 3/38; C09K 21/02

(52) U.S. Cl. CPC C08K 3/38; C08K 2003/387; C09K 21/02

(57) ABSTRACT

Disclosed is a fire retardant composition including at least one boron containing compound selected from disodium octaborate tetrahydrate, Colemanite, Ulexite, calcium borate, metaboric acid and boron oxide, and at least one further boron containing compound selected from anhydrous borax, borax pentahydrate, borax decahydrate, disodium octaborate tetrahydrate, Colemanite, Ulexite, calcium borate, metaboric acid, and boron oxide. Also disclosed is the use of a composition including only one boron containing compound, selected from anhydrous borax, borax pentahydrate, borax decahydrate, disodium octaborate tetrahydrate, Colemanite, Ulexite, calcium borate, metaboric acid, boron oxide and boric acid, as a fire retardant agent or heat transfer reducing agent. Further disclosed is a method of increasing fire resistance of a material or reducing heat transfer in a material, and a material of improved fire resistance and reduced heat transfer.

### FIELD OF THE INVENTION

The present invention relates generally to the field of fire retardant agents and to the use of such agents in the manufacture of fire resistant materials and products. In particular, the invention relates to fire retardant agents that may be used to improve the fire resistance of synthetic materials.

### BACKGROUND OF THE INVENTION

Each year, fires cause significant losses of life and property all over the world, and have a great impact and cost on society. To combat fire related losses, fire retardant materials have been developed, such as chemicals that can be applied to a combustible object to reduce flammability or retard the spread of fire over its surface.

For example, in the international application No. PCT/FI98/00698, published as WO 99/13022, a fire-retardant is described containing boric acid (H₃BO₃), borax (Na₂B₄O₇.10H₂O or Na₂B₄O₇.5H₂O), carboxymethylcellulose (CMC) and water. Carboxymethylcellulose is stated to be necessary in order to prevent crystallization of boric acid and borax, and also is stated to bind the protective agent inside the product and on its surface. In said application, the objects that can be protected against fire are primarily wood materials or cellulosic materials.

However, in our days, synthetic materials, such as different thermoplastic and thermoelastic resins, are used in an ever increasing proportion in areas as diverse as furniture, clothing, electric and electronic apparatuses and buildings, but also in vehicles such as cars, aeroplanes, spacecraft, ships, just to mention a few. Such materials suitably should have a fire resistance suited for their intended use. The most common fire retardants used in materials such as plastics are organic halogenated compounds, especially brominated compounds. However, the impact on health and environment of such compounds, e.g. by bioaccumulation, causes some concern.

In the international application No. PCT/EP2014/072238, published as WO 2015/055773, a fire-retardant composition is described, comprising boric acid and a salt of boric acid.

There however still remains a need for further fire retardant compositions. There also is a need for an agent and method for reducing heat transfer in various materials, such as building materials.

### SUMMARY OF THE INVENTION

One object of the present invention is to provide a new fire retardant composition useful for increasing the fire resistance of any material capable of catching fire.

One object of the present invention is to provide a new fire retardant composition useful for increasing the fire resistance of a synthetic material.

Still another object of the present invention is to provide a fire retardant composition that may be admixed directly into any material, e.g. a synthetic material during its processing into a product of manufacture.

Still a further object of the present invention is to provide a fire retardant composition that may be admixed not only with aqueous-based fluid materials, but also with and oil-based fluid materials, e.g. polymerizable compositions, curable polymeric compositions, paints, lacquers etc.

Another object of the present invention is to provide a fire retardant composition and a method of increasing the fire resistance of a synthetic material, such as a plastic material, with reduced impact on health and environment.

Another object of the present invention is to provide a method for reducing heat transfer in a material.

Another object of the invention is to provide a material having a reduced heat transfer. Such material, may be used e.g. as a heat shield, e.g. to protect an object against excessive heat, such as generated in a fire.

A further object of the present invention is to provide a method for increasing the fire resistance of a material.

Accordingly, a first aspect is a fire retardant composition comprising

at least one boron containing compound selected from disodium octaborate tetrahydrate (Na₂B₈O₁₃.4H₂O), CaB₃O₄(OH)₃.H₂O (Colemanite), NaCaB₅O₆(OH)₆.5(H₂O) (Ulexite), calcium borate (Ca₃(BO₃)₂), metaboric acid (H₃B₃O₆), and boron oxide, and

at least one further boron containing compound selected from anhydrous borax (Na₂B₄O₇), borax pentahydrate (Na₂B₄O₇.5H₂O), borax decahydrate (Na₂B₄O₇.10H₂O), disodium octaborate tetrahydrate (Na₂B₈O₁₃.4H₂O), CaB₃O₄(OH)₃.H₂O (Colemanite), NaCaB₅O₆(OH)₆.5(H₂O) (Ulexite), calcium borate (Ca₃(BO₃)₂), metaboric acid (H₃B₃O₆), boron oxide and boric acid, provided that boric acid is not present in the composition when said composition contains at least one compound which is a salt of boric acid.

In addition or as an alternative to protecting against fire, the inventive composition may be used to reduce heat transfer in a material.

In some embodiments, the composition comprises at least one boron containing compound selected from disodium octaborate tetrahydrate (Na₂B₈O₁₃.4H₂O), CaB₃O₄(OH)₃.H₂O (Colemanite), and NaCaB₅O₆(OH)₆.5(H₂O) (Ulexite).

In some embodiments, the at least one further boron containing compound is selected from anhydrous borax (Na₂B₄O₇), borax pentahydrate (Na₂B₄O₇.5H₂O), borax decahydrate (Na₂B₄O₇.10H₂O), disodium octaborate tetrahydrate (Na₂B₈O₁₃.4H₂O), CaB₃O₄(OH)₃.H₂O (Colemanite), NaCaB₅O₆(OH)₆.5(H₂O) (Ulexite), calcium borate (Ca₃(BO₃)₂), metaboric acid (H₃B₃O₆), and boron oxide.

In some embodiments, the at least one further boron containing compound is selected from disodium octaborate tetrahydrate (Na₂B₈O₁₃.4H₂O), CaB₃O₄(OH)₃.H₂O (Colemanite), NaCaB₅O₆(OH)₆.5(H₂O) (Ulexite), calcium borate (Ca₃(BO₃)₂), metaboric acid (H₃B₃O₆), and boron oxide.

In some embodiments, the at least one further boron containing compound is selected from disodium octaborate tetrahydrate (Na₂B₈O₁₃.4H₂O), CaB₃O₄(OH)₃.H₂O (Colemanite), NaCaB₅O₆(OH)₆.5(H₂O) (Ulexite), calcium borate (Ca₃(BO₃)₂), metaboric acid (H₃B₃O₆), and boron oxide.

In some embodiments, the at least one further boron containing compound is selected from disodium octaborate tetrahydrate (Na₂B₈O₁₃.4H₂O), CaB₃O₄(OH)₃.H₂O (Colemanite), and NaCaB₅O₆(OH)₆.5(H₂O) (Ulexite).

In some embodiments, the composition is in the form of a dry particulate material, e.g. a powder of granulate.

In some embodiments, the composition comprises a liquid vehicle for the boron containing compounds, e.g. the composition may have the form of a liquid solution or dispersion, or a gel, or paste.

Another aspect is a method of increasing fire resistance of a material by bringing the material into contact with a composition according to the invention.

Another aspect is a method of reducing heat transfer in a material by bringing the material into contact with a composition according to the invention.

The material preferably is a synthetic material, e.g. a thermosetting resin, a thermoplastic resin, an elastomer, a paint, a lacquer, a rubber, a woven fibre, a non-woven fibre, a glue, a foam, a carbon fibre, a glass fibre, or a gelcoat.

Another aspect is the use of a composition comprising as a fire retardant agent and/or heat transfer reducing agent, one or more boron containing compounds, e.g. only one boron containing compound, selected from anhydrous borax (Na₂B₄O₇), borax pentahydrate (Na₂B₄O₇.5H₂O), borax decahydrate (Na₂B₄O₇.10H₂O), disodium octaborate tetrahydrate (Na₂B₈O₁₃.4H₂O), CaB₃O₄(OH)₃.H₂O (Colemanite), NaCaB₅O₆(OH)₆.5(H₂O) (Ulexite), calcium borate (Ca₃(BO₃)₂), metaboric acid (H₃B₃O₆), boron oxide and boric acid.

In some embodiments, the one or more boron containing compounds are selected from disodium octaborate tetrahydrate (Na₂B₈O₁₃.4H₂O), and CaB₃O₄(OH)₃.H₂O (Colemanite), NaCaB₅O₆(OH)₆.5(H₂O) (Ulexite). In some embodiments, the boron containing compound is used as sole fire retardant agent or heat transfer reducing agent, e.g. as a dry powder or in a liquid or semi-liquid vehicle.

The material preferably is a synthetic polymeric material, e.g. e.g. a thermosetting resin, a thermoplastic resin, an elastomer, a paint, a lacquer, a rubber, a woven fibre, a non-woven fibre, a glue, a foam, a carbon fibre, a glass fibre, or a gelcoat.

In some embodiments, the synthetic polymeric material is in a fluid state (e.g. a viscous liquid) and the boron containing compound is admixed with the material before or after allowing the material to solidify.

A further aspect is a synthetic material of improved fire resistance and a product comprising such a material.

A further aspect is a synthetic material of reduced heat transfer and a product comprising such a material.

The composition of the invention may be prepared by mixing the boron containing compounds in the form of dry powders. Furthermore, the composition may be used in dry powder form, e.g. admixed into a synthetic polymeric resin, or admixed with components for forming a polymeric resin, prior to hardening of the resin. The composition also may be dissolved or dispersed in a suitable liquid vehicle before admixing the solution or dispersion with the material to be treated.

Further aspects, objects and advantages of the invention will become apparent from the below description, with some embodiments illustrated in the examples.

### DETAILED DESCRIPTION OF THE INVENTION

Any material capable of catching fire could usefully be treated by use of the fire retardant agent as defined herein. Such material may be organic, e.g. cotton, wood or a cellulose derived material, e.g. paper, paper pulp, or cardboard, or a synthetic material.

The term “synthetic material” as used herein in its broadest meaning refers to a material different from wood as well as different from a cellulosic product such as paper or cardboard.

More specifically, a synthetic material according to the present invention is a synthetic polymer, a thermosetting plastic, thermoplastic elastomer, a paint, a lacquer, a rubber, a woven fibre, a non-woven fibre, a glue, a foam, a carbon fibre, a glass fibre, or a gelcoat.

In general, the synthetic material comprises a polymeric resin. For example, a synthetic polymeric material that may be treated according to the present invention may be selected from various resins, such as polyester, epoxy, polyethylene terephthalate, polyethylene, high-density polyethylene, polyvinyl chloride, polyvinylidene chloride, low-density polyethylene, polypropylene, polystyrene, high impact polystyrene, polyamide, acrylonitrile butadiene styrene, polyethylene/acrylonitrile butadiene styrene, polycarbonate, polycarbonate/acrylonitrile butadiene styrene, polyurethane, melamine formaldehyde, phenol formaldehyde, polyetheretherketone, polyetherimide, aramide, polylactic acid, polymethyl methacrylate, polytetrafluoroethylene, urea-formaldehyde, etc.

In some embodiments, the material to be treated according to the present invention is a polymer, i.e. an organic or inorganic polymer, such as an organic synthetic polymer.

The term “fire-resistance” as used herein refers the ability of a material to resist combustion when the material is exposed to high temperatures (i.e. flame retardance), and/or the ability of a material to self-extinguish flames by virtue of physico-chemical reactions that occur when it is burned (i.e. flame suppression).

The term “improved fire resistance” or “increased fire resistance”, when referring to a material treated by the fire retardant composition of the present invention, refers to the fire resistance of the material after treatment with the inventive fire retardant composition, versus before treatment with the inventive fire retardant composition.

The term “fire retardant composition” (or flame retardant composition) as used herein refers to a composition having the ability to increase the fire resistance of a material with which it is brought into contact e.g. by surface treatment of the material, impregnation of the material, or by admixing with the material or a precursor (e.g. a curable resin) of the material.

The term “heat transfer” as used herein refers to the exchange or transport of thermal energy, essentially within a material or between the material and its surrounding.

The term “fluid state” refers to the state of a material having enough fluidity to allow admixing of the fire retardant composition in those embodiments where the fire retardant composition is mixed with the material. An example of a material in a fluid state is a (non-hardened) resin, e.g. an epoxy, polyurethane or polyester resin.

According to one aspect, a fire retardant composition is provided, comprising

at least one boron containing compound selected from (i) disodium octaborate tetrahydrate (Na₂B₈O₁₃.4H₂O), CaB₃O₄(OH)₃.H₂O (Colemanite), NaCaB₅O₆(OH)₆.5(H₂O) (Ulexite), calcium borate (Ca₃(BO₃)₂), metaboric acid (H₃B₃O₆), and boron oxide, and

at least one further boron containing compound selected from (ii) anhydrous borax (Na₂B₄O₇), borax pentahydrate (Na₂B₄O₇.5H₂O), borax decahydrate (Na₂B₄O₇.10H₂O), disodium octaborate tetrahydrate (Na₂B₈O₁₃.4H₂O), CaB₃O₄(OH)₃.H₂O (Colemanite), NaCaB₅O₆(OH)₆.5(H₂O) (Ulexite), calcium borate (Ca₃(BO₃)₂), metaboric acid (H₃B₃O₆), boron oxide and boric acid, provided that when the composition contains boric acid, it does not also contain a salt of boric acid.

In some embodiments, the fire retardant composition of the invention is comprised of one or more boron containing compounds selected from (i) and one or more boron containing compounds selected from (ii).

In some embodiments, the fire retardant composition comprises or is comprised of at least one boron containing compound selected from (i) disodium octaborate tetrahydrate (Na₂B₈O₁₃.4H₂O), CaB₃O₄(OH)₃.H₂O (Colemanite), NaCaB₅O₆(OH)₆.5(H₂O) (Ulexite), calcium borate (Ca₃(BO₃)₂), metaboric acid (H₃B₃O₆), and boron oxide, and at least one further boron containing compound selected from (ii) anhydrous borax (Na₂B₄O₇), borax pentahydrate (Na₂B₄O₇.5H₂O), borax decahydrate (Na₂B₄O₇.10H₂O), disodium octaborate tetrahydrate (Na₂B₈O₁₃.4H₂O), CaB₃O₄(OH)₃.H₂O (Colemanite), NaCaB₅O₆(OH)₆.5(H₂O) (Ulexite), calcium borate (Ca₃(BO₃)₂), metaboric acid (H₃B₃O₆), and boron oxide.

In some embodiments, the fire retardant composition comprises or is comprised of at least one boron containing compound selected from (i) disodium octaborate tetrahydrate (Na₂B₈O₁₃.4H₂O), CaB₃O₄(OH)₃.H₂O (Colemanite), NaCaB₅O₆(OH)₆.5(H₂O) (Ulexite), calcium borate (Ca₃(BO₃)₂), metaboric acid (H₃B₃O₆), and boron oxide, and at least one further boron containing compound selected from (ii) disodium octaborate tetrahydrate (Na₂B₈O₁₃.4H₂O), CaB₃O₄(OH)₃.H₂O (Colemanite), NaCaB₅O₆(OH)₆.5(H₂O) (Ulexite), calcium borate (Ca₃(BO₃)₂), metaboric acid (H₃B₃O₆), and boron oxide, i.e. both compounds are selected from (i).

In some embodiments, the composition of the invention is a mixture of disodium octaborate tetrahydrate and Colemanite.

In some embodiments, the composition of the invention is a mixture of disodium octaborate tetrahydrate and Ulexite.

In some embodiments, the composition of the invention is a mixture of disodium octaborate tetrahydrate and calcium borate (Ca₃(BO₃)₂)

In some embodiments, the composition of the invention is a mixture of disodium octaborate tetrahydrate and metaboric acid.

In some embodiments, the composition of the invention is a mixture of disodium octaborate tetrahydrate and boron oxide.

In some embodiments, the composition of the invention contains no further fire retardant agents other than the above mentioned compounds selected from (i) and (ii), or from (i).

In some embodiments, the composition of the invention contains no further boron containing fire retardant agents other than the above mentioned compounds selected from (i) and (ii) or from (i).

In some embodiments, e.g. when the composition contains at least one salt of boric acid, the composition of the invention does not contain boric acid.

The term “Colemanite” as used herein refers to the natural mineral or to a synthetic equivalent thereof, i.e. a compound of the chemical formula CaB₃O₄(OH)₃.H₂O, independently of its origin.

The term “Ulexite” as used herein refers to the natural mineral or to a synthetic equivalent thereof, i.e. a compound of the chemical formula NaCaB₅O₆(OH)₆.5(H₂O), independently of its origin.

The term “boron oxide” refers to boron trioxide (B₂O₃) and boron monoxide (B₂O), in particular boron trioxide.

In some embodiments, the fire retardant composition according to the present invention comprises at least 3, at least 4, at least 5, at least 6 or at least 7 boron containing compounds.

In some embodiments, the at least two boron containing compounds are present in amounts such as to provide weight ratios of one compound to the other of about 1:100, about 1:80, about 1:50, about 1:40, about 1: 30, about 1:20, about 1:15, about 1:10, about 1:8, about 1:6, about 1:5, about 1:4, about 1:3, about 1:2, or about 1:1.

In some embodiments, the at least two boron containing compounds are present in amounts such as to provide weight ratios of the compound selected from (i) to the compound selected from (ii), as defined herein above, of from 1:100 to 100:1, from 1:80 to 80: 1, from 1:50 to 50:1, from 1:40 to 40:1, from 1:30 to 30:1, from 1:20 to 20:1, from 1:10 to 10:1, from 1:8 to 8:1, from 1:6 to 6:1, from 1:5 to 5:1, from 1:4 to 4:1, from 1:3 to 3:1, or from 1:2 to 2:1, e.g. a ratio of 1:1.

In some embodiments, the composition of the present invention is a mixture of two different boron compounds as defined herein above, wherein the compounds are present in amounts such as to provide weight ratios of one compound to the other of from 1:100 to 100:1, from 1:80 to 80: 1, from 1:50 to 50:1, from 1:40 to 40:1, from 1:30 to 30:1, from 1:20 to 20:1, from 1:10 to 10:1, from 1:8 to 8:1, from 1:6 to 6:1, from 1:5 to 5:1, from 1:4 to 4:1, from 1:3 to 3:1, or from 1:2 to 2:1, e.g. a ratio of 1:1.

In some embodiments, the composition of the present invention comprises or is a mixture of more than two different boron compounds as defined herein above, e.g. 3, 4, 5, 6 or 7 different boron compounds, or all of the above mentioned boron containing compounds, wherein each compound may be present in an amount such as to provide a weight ratio with respect to any other compound in the mixture of from 1:100 to 100:1, from 1:80 to 80: 1, from 1:50 to 50:1, from 1:40 to 40:1, from 1:30 to 30:1, from 1:20 to 20:1, from 1:10 to 10:1, from 1:8 to 8:1, from 1:6 to 6:1, from 1:5 to 5:1, from 1:4 to 4:1, from 1:3 to 3:1, or from 1:2 to 2:1, e.g. a ratio of 1:1.

All of the boron containing compounds for use according to the present invention are commercially available from various sources, e.g. from Etimine OY in Finland. The CAS Registry Numbers of boron containing compounds used according to the invention are listed in Table 1.

TABLE 1

| boron containing compound | CAS Registry Number |
|---|---|
| anhydrous borax (Na₂B₄O₇) | 1330-43-4 |
| borax pentahydrate (Na₂B₄O₇•5H₂O) | 12179-04-3 |
| borax decahydrate (Na₂B₄O₇•10H₂O) | 1303-96-4 |
| disodium octaborate tetrahydrate | 12280-03-4 |
| (Na₂B₈O₁₃•4H₂O) | |
| Colemanite (CaB₃O₄(OH)₃•H₂O) | 12291-65-5 |
| Ulexite (NaCaB₅O₆(OH)₆•5(H₂O)) | 1319-33-1 |
| calcium borate (Ca₃(BO₃)₂) | 12007-56-6 |
| metaboric acid (H₃B₃O₆) | 13460-50-9 |
| boron oxide | 1303-86-2 |
| boric acid (H₃BO₃) | 10043-35-3 |

The Fire Retardant Composition

In some embodiments, the fire retardant composition is provided in the form of a dry powder or granulate. Said powder or granulate may be obtained by simply combining together the dry ingredients and grinding, if necessary, in a grinding apparatus, such as a ball mill.

Thus, in some embodiments, the fire retardant composition is an intimate mixture of components as defined herein above, e.g. a powder mixture with no further ingredients.

For example, the fire retardant composition may be an intimate mixture of at least two of the boron containing compounds listed herein above, e.g. a powder mixture of two such components, with no further ingredients.

In some embodiments, the fire retardant composition is an intimate mixture of 2, 3, 4, 5, 6 or 7 of the boron containing compounds listed herein above, in the form of a powder mixture of the components, with no further ingredients, in particular no further fire retardant agents.

In some embodiments, the fire retardant composition further comprises a liquid vehicle for the active ingredient. The liquid vehicle e.g. may comprise water or an organic solvent, e.g. acetone or an alcohol such as glycerol, ethylene glycol, methanol, ethanol or propanol; or a mixture of any of these.

In some embodiments, the liquid vehicle is water or aqueous. In some other embodiments, the liquid vehicle is an organic solvent or mixture of organic solvents, e.g. an alcohol, such as glycerol, ethylene glycol, methanol, ethanol or propanol, e.g. glycerol or ethylene glycol. In some embodiments, the liquid vehicle is glycerol. In some other embodiments, the liquid vehicle is ethylene glycol.

The composition of the invention may contain further functional agents, e.g. a sizing agent, e.g. for adhering the composition to a material to be treated by the composition, e.g. wood, paper, cardboard or cloth. For example, the composition may contain a polyvinyl alcohol sizing agent, such as may be purchased from BIM Kemi AB in Sweden.

In some embodiments, the mixture of boron components of the invention constitutes at least 40%, at least 50%, at least 60%, at least 70%, at least 80%, at least 90%, at least 95%, at least 97%, or at least 99% of the fire retardant composition, or even 100% of the fire retardant composition, by weight of the composition, whereby the remaining weight percentage optionally is comprised of the liquid vehicle only.

However, in embodiments wherein a liquid vehicle is used, the amount of the inventive mixture admixed with the liquid vehicle generally is such as to provide a liquid composition comprising about 20 to 95 parts by weight of liquid vehicle and about 80 to 5 parts by weight of the mixture of boron components of the invention, or 30 to 95 parts by weight of liquid vehicle and about 70 to 5 parts by weight of the mixture of boron components of the invention; e.g. about 35 to 90 parts by weight of liquid vehicle and about 65 to 10 parts by weight of the mixture of boron components of the invention, or about 40 to 70 parts by weight of liquid vehicle and about 60 to 30 parts by weight of the mixture of boron components of the invention, e.g. about 50 to 60 parts by weight of liquid vehicle and about 50 to 40 parts by weight of the mixture of boron components of the invention.

Thus, as an example, a fire retardant liquid composition of the invention may comprise about 50 to 60 parts by weight of liquid vehicle and about 50 to 40 parts by weight of the mixture of the invention.

In some embodiments, the liquid vehicle also contains additives such as e.g. surface active agents. Such additives may be present in amounts of e.g. 1 to 15 parts by weight, e.g. 1 to 10 parts by weight or 1 to 5 parts by weight based on the total weight of the composition. The surface active agent e.g. may be an ionic or non-ionic surface active agent, e.g. ionic, i.e. anionic, cationic or zwitterionic. The fire retardant composition of the invention however may also be free from any additive. In particular, the fire retardant composition of the invention does not need to contain—and suitably does not contain—any cellulosic additive such as carboxy methyl cellulose.

In some embodiments, the composition of the invention additionally comprises further boron compounds, in addition to the mixture defined herein above. For example, in some embodiments, the composition may comprise boric acid. In some other embodiments, the composition of the invention does not contain boric acid.

The Method for Preparing a Fire Retardant Composition

According to one aspect, a method for preparing a fire retardant composition also is provided, said method comprising mixing the selected boron containing compounds so as to obtain a mixture as defined herein above, and optionally a liquid vehicle as defined herein above.

The boron containing compounds may be admixed with the liquid vehicle as separate components, or as a pre-blended mixture. For example, the components, in the form of powders, may be dry blended together in any of the weight ratios indicated herein, and the powder mixture may be stored until transported to the actual site of use, where it is either admixed with a liquid vehicle before use or used as is, e.g. mixed directly into a polymeric resin.

In preparing a liquid form fire retardant composition, the selected boron containing compounds are admixed, either separately or as a pre-blend, with the liquid vehicle under constant or intermittent stirring. For example, a liquid formulation is prepared by admixing incremental portions of the components or the pre-blend of components in dry powder form, with stirring during addition, and stirring is continued for a time period between each addition. Each admixed portion may be allowed essentially to dissolve before adding the next portion. The portion is considered as essentially dissolved when the solution is homogeneous to the eye, i.e. no particle from the added portion remains visible.

The admixing of the mixture of the invention and the liquid vehicle suitably is performed at a temperature of from 15° C. up to a temperature below the boiling point of the selected liquid vehicle.

In order to obtain a homogeneous solution remaining stable over time, the liquid composition is suitably allowed to stir at a temperature of from 15° C. to a temperature below the boiling point of the selected liquid vehicle, e.g. 99° C., for a time period of at least 3 hours after completion of the admixing. Preferably, the liquid composition is stirred for a period of at least 6 hours, for a period of at least 8 hours, for a period of at least 10 hours, for a period of at least 12 hours, e.g. up to 15 hours, e.g. for a period of up to 48 hours, or for a period of up to 24 hours.

During the process of preparing the fire retardant composition, the temperature of the liquid phase preferably is kept within a range of from 15° C. and 99° C., or up to the boiling point of the liquid vehicle. For example, the temperature may be kept within a range of from 30° C. and 99° C., or between 50° C. and 99° C., e.g. between 70° C. and 99° C., e.g. between 80° C. and 99° C., or even higher, depending on the boiling point of the liquid vehicle.

The fire retardant composition obtained as a liquid phase may be concentrated by allowing at least a portion of the liquid vehicle to evaporate. In some embodiments, the fire retardant composition obtained as a liquid phase is dried by allowing the liquid vehicle to evaporate until a dry residue is obtained. Evaporation may be performed e.g. at a temperature of between 15° C. and 99° C., e.g. between 15° C. and 60° C., or between 15° C. and 40° C., such as between 15° C. and 30° C.

In some embodiments, the composition includes a sizing (or adhesive) agent, e.g. a polyvinyl alcohol sizing agent. For example, a sizing agent may be present at an amount of from 0.1 to 10% by weight, or from 0.5 to 5% by weight, or from 0.5 to 2% by weight.

In some embodiments, the fire retardant in dry powder or granulate form is obtained by admixing, as generally described herein above, a liquid vehicle and the selected boron containing compounds, at a temperature of from 15 to 99° C. so as to obtain a liquid phase, and optionally removing at least a portion of the liquid vehicle, e.g. by evaporation or lyophilisation.

The Use of a Boron Containing Compound

A further aspect relates to the use of a boron containing compound selected from anhydrous borax (Na₂B₄O₇), borax pentahydrate (Na₂B₄O₇.5H₂O), borax decahydrate (Na₂B₄O₇.10H₂O), disodium octaborate tetrahydrate (Na₂B₈O₁₃.4H₂O), CaB₃O₄(OH)₃.H₂O (Colemanite), NaCaB₅O₆(OH)₆.5(H₂O) (Ulexite), calcium borate (Ca₃(BO₃)₂), metaboric acid (H₃B₃O₆), boron oxide and boric acid, to increase fire resistance of a material and/or reduce heat transfer in the material.

In this aspect, the compound may be used as a stand-alone fire retarding agent or heat transfer reducing agent, without any other fire retardant, e.g. as a dry powder of the selected boron containing compound, or as a liquid solution or dispersion of the selected boron containing compound.

One embodiment is the use of a composition containing as sole boron containing compound, a compound selected from anhydrous borax (Na₂B₄O₇), borax pentahydrate (Na₂B₄O₇.5H₂O), borax decahydrate (Na₂B₄O₇.10H₂O), disodium octaborate tetrahydrate (Na₂B₈O₁₃.4H₂O), CaB₃O₄(OH)₃.H₂O (Colemanite), NaCaB₅O₆(OH)₆.5(H₂O) (Ulexite), calcium borate (Ca₃(BO₃)₂), metaboric acid (H₃B₃O₆), boron oxide and boric acid, to increase fire resistance of a material and/or reduce heat transfer in the material.

In some embodiments, the boron containing compound is selected from disodium octaborate tetrahydrate (Na₂B₈O₁₃.4H₂O), CaB₃O₄(OH)₃.H₂O (Colemanite), NaCaB₅O₆(OH)₆.5(H₂O) (Ulexite), calcium borate (Ca₃(BO₃)₂), metaboric acid (H₃B₃O₆), and boron oxide.

In some embodiments, the boron containing compound is selected from disodium octaborate tetrahydrate (Na₂B₈O₁₃.4H₂O), CaB₃O₄(OH)₃.H₂O (Colemanite), and NaCaB₅O₆(OH)₆.5(H₂O) (Ulexite), the boron containing compound is octaborate tetrahydrate.

In some embodiments, the boron containing compound is selected from Colemanite or Ulexite. In some embodiments, Colemanite is used. In some other embodiments, Ulexite is used.

In some embodiments, the boron containing compound is selected from anhydrous borax (Na₂B₄O₇), borax pentahydrate (Na₂B₄O₇.5H₂O), or borax decahydrate (Na₂B₄O₇.10H₂O).

In some embodiments, the boron containing compound is calcium borate (Ca₃(BO₃)₂). In some other embodiments, the boron containing compound is selected from metaboric acid (H₃B₃O₆), boron oxide and boric acid, e.g. the compound is metaboric acid or boron oxide, or the compound is boron oxide.

In still other embodiments, the compound is metaboric acid or boric acid, e.g. metaboric acid.

The composition comprising only one boron containing compound may be prepared as generally described for the compositions herein above, comprising at least two boron containing compounds, using corresponding amounts and proportions in relation to treated material of the selected boron containing compound.

The composition containing only one boron containing, or the boron containing compound per se, may be generally used in the same way as the fire retardant composition described herein, e.g. in dry particulate form, or dissolved or dispersed in a liquid vehicle as mentioned herein, and added to a material, such as a polymeric synthetic material, at the weight ratios as generally described herein.

The boron containing compound used according to this aspect also may be admixed or combined with any suitable further component, such as a carrier or diluent, or any other functional agent, e.g. an adhesive agent, a sizing agent, a colorant etc.

Thus the fire retardant agent of the present invention may be a composition comprising at least two boron containing compounds as defined herein, or a boron containing compound per se as defined herein, or in admixture with a carrier or any other suitable component, or a boron containing compound as defined herein, in a liquid vehicle.

Use of the Fire Retardant Agent of the Invention

The fire retardant agent of the invention is added to or brought into contact with the material to be protected in an amount sufficient to improve the fire resistance of the material, and the skilled person will be able to determine such amount without undue burden.

It should be realized that the amount of fire retardant agent added to or brought into contact with the material will depend on the fire resistance that is desired or necessary, having regard e.g. to the intended use of the material. Generally, though, the fire retardant agent will be added to a material to be treated in such an amount as to provide a treated material comprising from 1 to 30 percent by weight of boron containing compound(s) as defined herein e.g. from 1 to 20 percent by weight, or from 1 to 10 percent by weight, or from 2 to 30 percent by weight, e.g. from 2 to 20 percent by weight, or from 2 to 10 percent by weight; or from 5 to 30 percent by weight, e.g. from 5 to 20 percent by weight, or from 5 to 15 percent by weight, or from 5 to 10 percent by weight; or from 10 to 30 percent by weight, e.g. from 10 to 20 percent by weight; or from 10 to 15 percent by weight, based on the total weight of material to be treated and boron containing compound(s).

For example, in some embodiments, a fire retardant composition of the invention, comprising at least two boron containing compounds as defined herein above, at a weight ratio of from 1:1 to 1:10, is admixed with a polymeric resin before hardening at from 5 to 75% by weight of boron containing compounds and from 25 to 95% of polymeric resin, in particular from from 5 to 50% by weight of boron containing compounds, and from and from 50 to 95% of polymeric resin, or from 5 to 35% by weight of boron containing compounds, and from and from 65 to 95% of polymeric resin, e.g. from 10 to 35% by weight of boron containing compounds, and from and from 65 to 90% of polymeric resin.

In these embodiments, the polymeric resin also may comprise other components conventionally added to such material.

While generally not considered necessary in order to improve the fire resistance of the treated material, other fire retardants used within the field may also be added to the material, in combination with the fire retardant composition of the present invention.

In one advantageous embodiment, the fire retardant composition of the present invention is admixed with a synthetic polymeric material in a fluid state. A synthetic polymeric material may be selected from various polymeric resins and plastics, such as polyester, epoxy, polyethylene terephthalate, polyethylene, high-density polyethylene, polyvinyl chloride, polyvinylidene chloride, low-density polyethylene, polypropylene, polystyrene, high impact polystyrene, polyamide, acrylonitrile butadiene styrene, polyethylene/acrylonitrile butadiene styrene, polycarbonate, polycarbonate/acrylonitrile butadiene styrene, polyurethane, melamine formaldehyde, phenol formaldehyde, polyetheretherketone, polyetherimide, aramide, polylactic acid, polymethyl methacrylate, polytetrafluoroethylene, urea-formaldehyde, etc.

In some embodiments of the invention, the fire retardant agent is a liquid, e.g. aqueous, solution of the boron containing compound(s) as defined herein above. It is a surprising and advantageous feature that an aqueous solution may be admixed with a polymeric material as defined herein above. For example, the present inventors have very surprisingly found that a liquid fire retardant composition according to the present invention, comprising an aqueous vehicle, may be admixed with a non-hardened resin, for instance, an epoxy resin or polyester resin, to provide a homogeneous mixture to which hardener may subsequently be added.

One aspect of the present invention therefore also refers to a method of increasing the fire resistance of a synthetic material by admixing into said material, in a fluid state, an aqueous fire retardant agent as defined herein. Such synthetic material, which may be non-aqueous (i.e. essentially free from water) may be e.g. an oil, a petroleum product, an oil-based viscous liquid, such as an oil-based paint, a resin etc. The aqueous solution alternatively may be replaced by e.g. an alcoholic solution, e.g. an ethanol, propanol, or similar alcohol solution, e.g. glycerol or polyethylene glycol.

In some embodiments the fire retardant agent is applied to the surface of a solid synthetic material, and optionally allowed to impregnate part or all of the material. The application may be performed by any means, such as by spraying, by wet vapour, by dry vapour, by spreading, by dipping etc. In some embodiments, the fire retardant agent of the invention is allowed to penetrate into depth of the material, e.g. using an applied vacuum suction.

The application to the surface of a synthetic material may be performed at a temperature between e.g. 30 to 160° C. At the higher application temperature, the fire retardant agent of the invention may be a vapour which is made to condense on the surface of the material to be treated. As an example the material to be treated, e.g. in the form of a panel, is transported on a conveyor belt into a chamber containing the fire retardant agent in vapour form.

After treatment of the synthetic material with the fire retardant agent of the present invention the material may be subjected to further processing to a desired end product. Thus, a resin may be mixed with a fire retardant composition according to the present invention, and optionally also combined with any other ingredients, e.g. conventional additives, fibre reinforcements etc., and processed to the end product by usual techniques, well known to the person of ordinary skill in the field.

In some embodiments, a synthetic material is treated by addition of a fire retardant agent according to the invention when in a fluid state, e.g. as a non-hardened plastic, and is then processed into a solid state material, e.g. by addition of hardener, and optionally further processed, and is then further brought into contact with a fire retardant composition of the invention by a surface and optionally impregnation treatment.

As noted herein above, the synthetic material to may be selected from any type of polymeric synthetic material, e.g. a thermoplastic polymer, an elastomer, or a thermosetting polymer. For example, in some embodiments, the synthetic material is a thermosetting polymer (i.e. thermosetting resin) and the fire retardant composition of the invention is added to said polymer before hardening the polymer.

In some embodiments, when the fire retardant agent comprises a liquid vehicle, such as water, the polymeric material may be submitted to a drying step after hardening. For example, drying may be performed in a convection oven, e.g. a convection oven at a temperature of from 30 to 95° C.

The synthetic material with improved fire resistance may advantageously be used as a construction material, isolation material, cable insulations, filler material, paint, surface coverings, in the productions of yarns, textiles, foams, e.g. styrofoams, polyurethane foams, honeycomb foams, in sandwich structures, composite materials, fibre reinforced plastics, gelcoats, etc. In particular, the synthetic material with improved fire resistance may suitably be used in the automotive industry, in cars, buses, lorries, aeroplanes, ships, boats, trains, spacecraft, in buildings, off-shore oil platforms, in household appliances, electronic equipment, computers, television sets, in catalysts, floor coverings, carpet paddings, Plexiglas, wood-plastic composites, glues, clothes, such as functional clothes, in-door furniture, furniture fillings, e.g. seat fillings, seat fillings for automotive vehicles, interior parts for automotive vehicles, wall covers, etc.

A very advantageous feature of the fire retardant agent of the present invention is that it not only is capable of providing increased fire resistance, but it also is capable of reducing heat transfer in the treated material. The composition of the present invention therefore may be used in the manufacturing of materials for use a heat shields, e.g. thermally insulating coatings.

A further advantageous feature of the fire retardant agent of the present invention resides in the fact that it may be admixed, e.g. in the form of a dry particulate material, with almost any type of material, e.g. a low-viscous, medium-viscous or highly viscous fluid material, e.g. a polymeric melt before casting.

For example, the fire retardant agent of the invention may be admixed with a resin, e.g. a polyester resin, or similar material, and a coating of the resin then may be applied onto an item to be protected against excessive heat, e.g. a steel structural element.

As an alternative, a fire retardant agent of the invention in a liquid vehicle may be applied, e.g. by spraying, onto any material that needs protection against fire.

### EXAMPLES

Boron containing compounds commercially available from AB Midnight Holding, Finland, were used as ingredients in the Examples and are identified in Table 2.

TABLE 2

| Ingredient | Chemical name | CAS Reg. No. |
|---|---|---|
| Midnight DryMix 100 | boric acid (H₃BO₃) | 10043-35-3 |
| Midnight DryMix 200 | borax pentahydrate (Na₂B₄O₇•5H₂O) | 12179-04-3 |
| Midnight DryMix 300 | disodium octaborate tetrahydrate | 12280-03-4 |
| | (Na₂B₈O₁₃•4H₂O) | |
| Midnight DryMix 400 | Colemanite (CaB₃O₄(OH)₃•H₂O) | 12291-65-5 |
| Midnight DryMix 500 | Ulexite (NaCaB₅O₆(OH)₆•5(H₂O)) | 1319-33-1 |
| Midnight DryMix 600 | calcium borate (Ca₃(BO₃)₂) | 12007-56-6 |
| Midnight DryMix 700 | metaboric acid (H₃B₃O₆) | 13460-50-9 |
| Midnight DryMix 800 | Boron oxide (B₂O₃, B₂O) | 1303-86-2 |

In some of the examples, purified water has been used as a liquid vehicle. However, also normal tap water may also be used, e.g. if there is no need for a high purity material, or other liquid vehicles as mentioned herein.

### Example 1

Purified water (65 parts by weight) at a temperature of 20-80° C. was mixed with Midnight DryMix 300 (25 parts by weight) and Midnight DryMix 400 (10 parts by weight). The obtained composition was mixed with a liquid (i.e. not yet hardened) polyester resin at a dosage of 35% by weight (i.e. 35 parts by weight of composition and 65 parts by weight of resin), giving a homogeneous liquid phase mixture. The obtained material had an improved fire resistance and reduced heat transfer.

### Example 2

Midnight DryMix 300 and Midnight DryMix 400 at a weight ratio of 2.5:1 (35% by weight) were admixed with a liquid polyester resin (65% by weight) and the resin then was cast to provide a fire protection and heat shield material.

### Example 3

Midnight DryMix 300 and Midnight DryMix 400 at a weight ratio of 6:1 (35% by weight) were admixed with a liquid polyester resin (65% by weight) and the resin then was cast to provide a fire protection and heat shield material.

### Example 4

Purified water (65 parts by weight) at a temperature of 20-80° C. was mixed with Midnight DryMix 300 (25 parts by weight) and Midnight DryMix 400 (10 parts by weight). The obtained composition was mixed with a liquid polyester resin at a dosage of 5% by weight, giving a homogeneous liquid phase mixture. The obtained material had an improved fire resistance and reduced heat transfer.

### Example 5

Example 1 was repeated, but Midnight DryMix 400 was replaced by Midnight DryMix 500. The obtained material had an improved fire resistance and reduced heat transfer.

### Example 6

Example 2 was repeated, but Midnight DryMix 400 was replaced by Midnight DryMix 500. The obtained material had an improved fire resistance and reduced heat transfer.

### Example 7

Example 3 was repeated, but Midnight DryMix 400 was replaced by Midnight DryMix 500. The obtained material had an improved fire resistance and reduced heat transfer.

### Example 8

Example 4 was repeated, but Midnight DryMix 400 was replaced by Midnight DryMix 500. The obtained material had an improved fire resistance and reduced heat transfer.

### Example 9

Example 1 was repeated, but Midnight DryMix 400 was replaced by Midnight DryMix 600. The obtained material had an improved fire resistance and reduced heat transfer.

### Example 10

Example 2 was repeated, but Midnight DryMix 400 was replaced by Midnight DryMix 600. The obtained material had an improved fire resistance and reduced heat transfer.

### Example 11

Example 3 was repeated, but Midnight DryMix 400 was replaced by Midnight DryMix 600. The obtained material had an improved fire resistance and reduced heat transfer.

### Example 12

Example 4 was repeated, but Midnight DryMix 400 was replaced by Midnight DryMix 600. The obtained material had an improved fire resistance and reduced heat transfer.

### Example 13

Example 1 was repeated, but Midnight DryMix 400 was replaced by Midnight DryMix 700. The obtained material had an improved fire resistance and reduced heat transfer.

### Example 14

Example 2 was repeated, but Midnight DryMix 400 was replaced by Midnight DryMix 700. The obtained material had an improved fire resistance and reduced heat transfer.

### Example 15

Example 3 was repeated, but Midnight DryMix 400 was replaced by Midnight DryMix 700. The obtained material had an improved fire resistance and reduced heat transfer.

### Example 16

Example 4 was repeated, but Midnight DryMix 400 was replaced by Midnight DryMix 700. The obtained material had an improved fire resistance and reduced heat transfer.

### Example 17

Example 1 was repeated, but Midnight DryMix 400 was replaced by Midnight DryMix 800. The obtained material had an improved fire resistance and reduced heat transfer.

### Example 18

Example 2 was repeated, but Midnight DryMix 400 was replaced by Midnight DryMix 800. The obtained material had an improved fire resistance and reduced heat transfer.

### Example 19

Example 3 was repeated, but Midnight DryMix 400 was replaced by Midnight DryMix 800. The obtained material had an improved fire resistance and reduced heat transfer.

### Example 20

Example 4 was repeated, but Midnight DryMix 400 was replaced by Midnight DryMix 800. The obtained material had an improved fire resistance and reduced heat transfer.

### Example 21

Example 1 was repeated, but Midnight DryMix 400 was replaced by Midnight DryMix 200. The obtained material had an improved fire resistance and reduced heat transfer.

### Example 22

Example 2 was repeated, but Midnight DryMix 400 was replaced by Midnight DryMix 200. The obtained material had an improved fire resistance and reduced heat transfer.

### Example 23

Example 3 was repeated, but Midnight DryMix 400 was replaced by Midnight DryMix 200.

The obtained material had an improved fire resistance and reduced heat transfer.

### Example 24

Example 4 was repeated, but Midnight DryMix 400 was replaced by Midnight DryMix 200. The obtained material had an improved fire resistance and reduced heat transfer.

### Example 25

Midnight DryMix 300 (50 parts by weight) and Midnight DryMix 400 (50 parts by weight) were mixed together to obtain a dry particulate material. The particulate material was mixed with a liquid (i.e. not yet hardened) polyester resin at a dosage of 20% by weight, to obtain a homogenous mixture. The obtained material had an improved fire resistance and reduced heat transfer.

### Example 26

Example 25 was repeated, but Midnight DryMix 400 was replaced by Midnight DryMix 200. The obtained material had an improved fire resistance and reduced heat transfer.

### Example 27

Example 25 was repeated, but Midnight DryMix 400 was replaced by Midnight DryMix 500. The obtained material had an improved fire resistance and reduced heat transfer.

### Example 28

Example 25 was repeated, but Midnight DryMix 400 was replaced by Midnight DryMix 600. The obtained material had an improved fire resistance and reduced heat transfer.

### Example 29

Example 25 was repeated, but Midnight DryMix 400 was replaced by Midnight DryMix 700. The obtained material had an improved fire resistance and reduced heat transfer.

### Example 30

Example 25 was repeated, but Midnight DryMix 400 was replaced by Midnight DryMix 800. The obtained material had an improved fire resistance and reduced heat transfer.

### Example 31

Purified water (75 parts by weight) at a temperature of 20-80° C. was mixed with Midnight DryMix 100 (25 parts by weight) as only boron containing compound. The obtained composition was mixed with a liquid (i.e. not yet hardened) polyester resin at a dosage of 35% by weight (i.e. 35 parts by weight of composition and 65 parts by weight of resin), giving a homogeneous liquid phase mixture. The resin was allowed to harden. The obtained material had an improved fire resistance and reduced heat transfer.

### Example 32

A mixture of 50% by weight of DryMix 100 and 50% by weight of DryMix 300 was applied to the surface of two intertwined, electrical conductors, by bringing the 2-conductor twine into contact with the powder mixture. To this effect, the powder mixture was placed in a container and the twine, on a roll, was unwound from the roll and passed through the powder mixture, whereby a thin coating of the powder adhered to the surface of the twine. A PVC coating having a thickness of about 2-4 mm was then applied to the surface of the conductor twine, by use of an extruder. The obtained cable had an improved fire resistance and passed the VW-1 (UL 1581) flame test.

### Example 33

Example 32 was repeated, using a mixture of 50% by weight of DryMix 300 and 50% by weight of DryMix 700. The obtained cable had an improved fire resistance and passed the VW-1 (UL 1581) flame test.

### Example 34

Example 32 was repeated, using a mixture of 50% by weight of DryMix 300 and 50% by weight of DryMix 800. The obtained cable had an improved fire resistance and passed the VW-1 (UL 1581) flame test.

### Example 35

Example 32 was repeated, using a mixture of 50% by weight of DryMix 700 and 50% by weight of DryMix 800. The obtained cable had an improved fire resistance and passed the VW-1 (UL 1581) flame test.

### Example 36

Example 32 was repeated using DryMix 100 powder. The obtained cable had an improved fire resistance and passed the VW-1 (UL 1581) flame test.

### Examples 37-39

Example 36 was repeated, but using DryMix 300 powder, DryMix 700 powder, and DryMix 800 powder, respectively, instead of DryMix 100. In each case the obtained cable had an improved fire resistance and passed the VW-1 (UL 1581) flame test.

Examples 32-39 illustrate that according to the present invention, a boron containing composition as defined herein may be used to improve fire resistance of e.g. electrical cables and other articles, in a method simply comprising distributing the composition e.g. in the form of a powder, on the surface of the article, and the applying an overlying coating on the treated surface. Thus, by such method, an object, such as an electrical cable of improved fire resistance is obtainable, comprising a layer of a boron containing composition according to the present invention, covered by a coating or surface layer of a suitable material, e.g. a thermoplastic resin, such as PVC.

1-18. (canceled)

19. A fire retardant and/or heat transfer reducing composition comprising
at least one boron containing compound selected from disodium octaborate tetrahydrate (Na₂B₃O₁₃.4H₂O), CaB₃O₄(OH)₃.H₂O (Colemanite), NaCaB₅O₆(OH)₆.5(H₂O) (Ulexite), calcium borate (Ca₃(BO₃)₂), metaboric acid (H₃B₃O₆), and boron oxide (B₂O₃, B₂O), and
at least one further boron containing compound selected from anhydrous borax (Na₂B₄O₇), borax pentahydrate (Na₂B₄O₇.5H₂O), borax decahydrate (Na₂B₄O₇.10H₂O), disodium octaborate tetrahydrate (Na₂B₃O₁₃.4H₂O), CaB₃O₄(OH)₃.H₂O (Colemanite), NaCaB₅O₆(OH)₆.5(H₂O) (Ulexite), calcium borate (Ca₃ (BO₃), metaboric acid (H₃B₃O₆), boron oxide (B₂O₃, B₂O), and boric acid (H₃BO₃),
provided that if the composition comprises a boric acid salt, said composition does not contain boric acid.

20. The composition according to claim 19, comprising at least one boron containing compound selected from disodium octaborate tetrahydrate (Na₂B₃O₁₃.4H₂O), CaB₃O₄(OH)₃.H₂O (Colemanite), and NaCaB₅O₆(OH)₆.5(H₂O) (Ulexite).

21. The composition according to claim 19, wherein the at least one further boron containing compound is selected from anhydrous borax (Na₂B₄O₇), borax pentahydrate (Na₂B₄O₇.5H₂O), borax decahydrate (Na₂B₄O₇.10H₂O), disodium octaborate tetrahydrate (Na₂B₈O₁₃.4H₂O), CaB₃O₄(OH)₃.H₂O (Colemanite), NaCaB₅O₆(OH)₆.5(H₂O) (Ulexite), calcium borate (Ca₃(BO₃)₂), metaboric acid (H₃B₃O₆), and boron oxide.

22. The composition according to claim 21, wherein the at least one further boron containing compound is selected from disodium octaborate tetrahydrate (Na₂B₈O₁₃.4H₂O), CaB₃O₄(OH)₃.H₂O (Colemanite), NaCaB₅O₆(OH)₆.5(H₂O) (Ulexite), calcium borate (Ca₃(BO₃)₂), metaboric acid (H₃B₃O₆), and boron oxide.

23. The composition according to claim 22, wherein the at least one further boron containing compound is selected from disodium octaborate tetrahydrate (Na₂B₈O₁₃.4H₂O), CaB₃O₄(OH)₃.H₂O (Colemanite), and NaCaB₅O₆(OH)₆.5(H₂O) (Ulexite).

24. The composition according to claim 19, wherein the mixture of boron components constitutes at least 80% by weight of the fire retardant composition.

25. The composition according to claim 19, in the form of a dry particulate material.

26. A fire retardant and/or heat transfer reducing liquid formulation, comprising a composition according to claim 19, dissolved or suspended in a liquid vehicle.

27. A method of increasing fire resistance of a material or reducing heat transfer in the material by bringing the material into contact with a composition according to claim 19.

28. The method according to claim 27, wherein the material is a synthetic material.

29. The method according to claim 28, wherein the synthetic material is a polymeric material.

30. The method according to claim 28, wherein the synthetic material is a thermosetting resin, a thermoplastic resin, an elastomer, a paint, a lacquer, a rubber, a woven fibre, a non-woven fibre, a glue, a foam, a carbon fibre, a glass fibre, or a gelcoat.

31. A method for retarding fire or reducing heat transfer by use, of one or more boron containing compounds selected from anhydrous borax (Na₂B₄O₇), borax pentahydrate (Na₂B₄O₇.5H₂O), borax decahydrate (Na₂B₄O₇.10H₂O), disodium octaborate tetrahydrate (Na₂B₈O₁₃.4H₂O), CaB₃O₄(OH)₃.H₂O (Colemanite), NaCaB₅O₆(OH)₆.5(H₂O) (Ulexite), calcium borate (Ca₃(BO₃)₂, metaboric acid (H₃B₃O₆), boron oxide (B₂O₃, B₂O) and boric acid (H₃BO₃), wherein the one or more boron containing compounds are used as sole fire retardant agent or heat transfer reducing agent.

32. The method according to claim 31, wherein the one or more boron containing compounds are selected from disodium octaborate tetrahydrate (Na₂B₈O₁₃.4H₂O), and CaB₃O₄(OH)₃.H₂O (Colemanite), NaCaB₅O₆(OH)₆.5(H₂O) (Ulexite).

33. The method according to claim 31, wherein one only boron containing compound is used.

34. The method according to claim 31, for improving fire resistance of or reducing heat transfer in a synthetic polymeric material.

35. The method according to claim 34, wherein synthetic polymeric material is in a liquid state and the boron containing compound is admixed with the material before allowing the material to solidify.

36. The method according to claim 34, wherein the synthetic material is a thermosetting resin, a thermoplastic resin, an elastomer, a paint, a lacquer, a rubber, a woven fibre, a non-woven fibre, a glue, a foam, a carbon fibre, a glass fibre, or a gelcoat.
